(19) United States
(12) Patent Application Publication
(10) Pub. No.: US 2019/0227688 A1
(43) Pub. Date: Jul. 25, 2019

(54) HEAD MOUNTED DISPLAY DEVICE AND CONTENT INPUT METHOD THEREOF

(71) Applicant: SHENZHEN ROYOLE TECHNOLOGIES CO. LTD., Shenzhen, Guangdong (CN)

(72) Inventors: Yiqi WANG, Shenzhen, Guangdong (CN); Shuangxin CHEN, Shenzhen, Guangdong (CN); Peichen XU, Shenzhen, Guangdong (CN)

(21) Appl. No.: 16/330,215

(22) PCT Filed: Dec. 8, 2016
(86) PCT No.: PCT/CN2016/109011

§ 371 Date: Mar. 4, 2019

(51) Int. Cl. G06F 3/0488; G06F 3/041; G02B 27/01; G06F 1/16; G06F 3/01; H04R 1/10

(52) U.S. Cl. CPC G06F 3/0488; G06F 3/041; G02B 27/0172; G02B 2027/014; G06F 3/017; H04R 1/1008; G06F 1/1673

(57) ABSTRACT

The present disclosure provides a content input method, applied to a head mounted display device, which comprises a headphone apparatus, a display apparatus and a touch input apparatus. The method comprises steps of: controlling the display apparatus to display a soft keyboard input interface in response to a content input request, the soft keyboard input interface comprising an input box and a plurality of virtual keys arranged circularly; determining a virtual key to be input in response to a first touch action applied an annular first touch pad of the touch input apparatus; and displaying a character in the input box when the virtual key to be input is determined to be the character. The present disclosure further provides a head mounted display device. The head mounted display device and the content input method of the present disclosure can help the user to input after wearing the head mounted display device.

### RELATED APPLICATION

The present application is a National Phase of International Application Number PCT/CN2016/109011, filed Dec. 8, 2016.

### TECHNICAL FIELD

This present disclosure relates to display devices, and more particularly, to a head mounted display device and a content input method thereof.

### BACKGROUND

At present, the head mounted display devices have gradually become popular for their convenience and ability to achieve stereoscopic display and stereo sound. In recent years, with the advent of virtual reality (VR) technology, the head-mounted display devices have been used more widely as hardware support devices for VR technology. Since the user cannot see the outside environment after wearing a head-mounted display device, it is often inconvenient for input using existing input device.

### SUMMARY

Embodiments of the present disclosure provide a head mounted display device and a content input method thereof, which can help user input content.

Embodiments of the present disclosure provide a head mounted display device, which comprises a headphone apparatus, a display apparatus, a touch input apparatus, and a processor. Wherein, the touch input apparatus comprises an annular first touch pad. The first touch pad is configured to detect touch operations. The processor is configured to control the display apparatus to display a soft keyboard input interface in response to a content input request. The soft keyboard input interface comprises an input box and a plurality of virtual keys arranged circularly. The processor is further configured to determine a virtual key to be input in response to a first touch action applied to the first touch pad, and display a character in the input box when the virtual key to be input is determined to be the character.

Embodiments of the present disclosure provide a content input method, applied to a head mounted display device. The head mounted display device comprises a headphone apparatus, a display apparatus and a touch input apparatus. Where, the method comprises steps of: controlling the display apparatus to display a soft keyboard input interface in response to a content input request, the soft keyboard input interface comprising an input box and a plurality of virtual keys arranged circularly; determining a virtual key to be input in response to a first touch action applied to an annular first touch pad of the touch input apparatus; and displaying a character in the input box when the virtual key to be input is determined to be the character.

The head mounted display device and the content input method thereof of the present disclosure can help the user to input character content after wearing the head mounted display device.

### BRIEF DESCRIPTION OF THE ACCOMPANYING DRAWINGS

To describe technology solutions in the embodiments of the present disclosure more clearly, the following briefly introduces the accompanying drawings required for describing the embodiments. Obviously, the accompanying drawings in the following description show merely some embodiments of the present disclosure, those of ordinary skill in the art may also derive other obvious variations based on these accompanying drawings without creative efforts.

FIG. 1 is a schematic diagram of a head mounted display device according to one embodiment of the present disclosure.

FIG. 2 is a block diagram of a head mounted display device according to one embodiment of the present disclosure.

FIG. 3 is a schematic diagram of a touch input apparatus of a head mounted display device according to one embodiment of the present disclosure.

FIG. 4 is a schematic diagram of a soft keyboard input interface displayed by a display apparatus of the head mounted display device according to one embodiment of the present disclosure.

FIG. 5 is a schematic diagram of inputting characters in the soft keyboard input interface according to one embodiment of the present disclosure.

FIG. 6 is a schematic diagram showing a soft keyboard input interface when the language category of the virtual key of the soft keyboard input interface is a Chinese Pinyin category according to one embodiment of the present disclosure.

FIG. 7 is a schematic diagram showing a soft keyboard input interface when the language category of the virtual key of the soft keyboard input interface is a lowercase letter category according to one embodiment of the present disclosure.

FIG. 8 is a schematic diagram showing a soft keyboard input interface when the language category of the virtual key of the soft keyboard input interface is a number and punctuation category according to one embodiment of the present disclosure.

FIGS. 9 to 11 are schematic diagrams showing an input process when the language category of the virtual key of the soft keyboard input interface is the Chinese Pinyin category according to one embodiment of the present disclosure.

FIG. 12 is a schematic diagram of a head mounted display device according to another embodiment of the present disclosure.

FIG. 13 is a flowchart of a content input method according to one embodiment of the present disclosure.

FIG. 14 is a flowchart of a content input method when the language category of the virtual key of the soft keyboard input interface is the Chinese pinyin category according to one embodiment of the present disclosure.

### DETAILED DESCRIPTION OF ILLUSTRATED EMBODIMENTS

The technical solution in the embodiments of the present disclosure will be described clearly and completely hereinafter with reference to the accompanying drawings in the embodiments of the present disclosure. Obviously, the described embodiments are merely some but not all the embodiments of the present disclosure. All other embodiments obtained by a person of ordinary skill in the art based on the embodiments of the present disclosure without creative efforts shall all fall within the protection scope of the present disclosure.

Referring to FIG. 1, a schematic diagram of a head mounted display device 100 according to one embodiment of the present disclosure is provided. As shown in FIG. 1, the head mounted display device 100 includes a headphone apparatus 1 and a display apparatus 2. The headphone apparatus 1 is configured to output sound. The display apparatus 2 is configured to output display images.

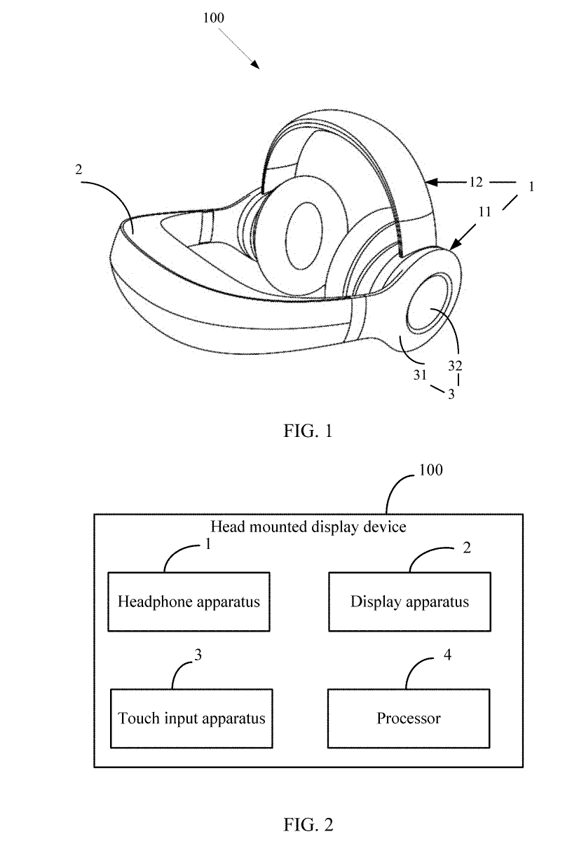

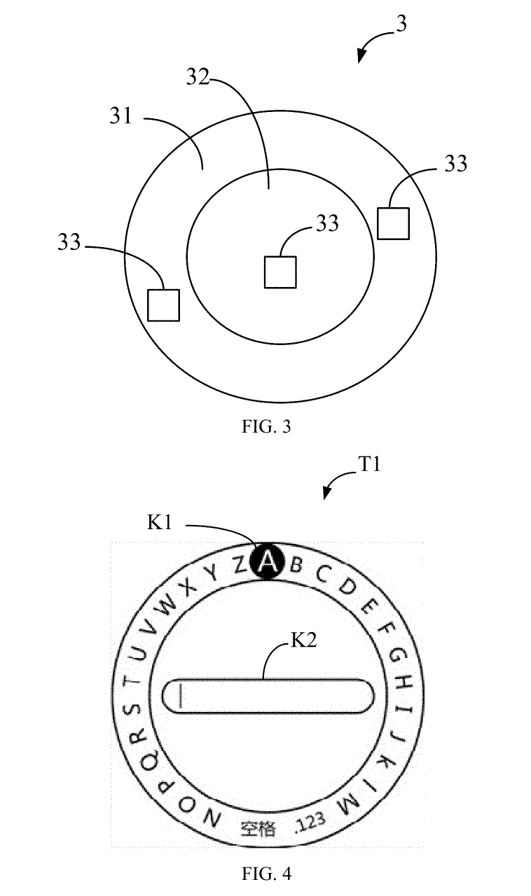

Referring to FIGS. 2 and 3, FIG. 2 is a block diagram of the head mounted display device 100. The head mounted display device 100 further includes a touch input apparatus 3 and a processor 4 in addition to the headphone apparatus 1 and the display apparatus 2.

The processor 4 is electrically coupled to the headphone apparatus 1, the display apparatus 2 and the touch input apparatus 3. As shown in FIG. 3, the touch input apparatus 3 further includes a first touch pad 31. The first touch pad 31 is configured to detect touch operations. In some embodiments, the first touch pad 31 has an annular shape.

Referring further to FIG. 4, the process 4 controls the display apparatus 2 to display a soft keyboard input interface T1 in response to a content input request. The soft keyboard input interface T1 includes a plurality of virtual keys K1 arranged circularly. In one language category input mode, each virtual key K1 is a character or a language category switching button/icon, and each virtual key K1 is used for the user to input a single character under the language category or to perform a switching operation to switch the language category to another language category. The processor 4 determines the virtual key K1 selected by the user, that is, determines the virtual key K1 to be input by the user in response to a first touch action applied to the first touch pad 31.

The first touch action is a sliding touch of a circular track along the first touch pad 31 and remains a preset time duration at a corresponding position of the virtual key K1 that needs to be input. For example, as shown in FIG. 4, if the letter “A” needs to be input, the first touch action can slide along the first touch pad 31 and remain at the position of the letter “A” for a preset time duration. The preset time duration may be 2 seconds or other suitable time duration.

In some embodiments, the touch positions of the first touch pad 31 and the positions of virtual keys K1 of the soft keyboard input interface T1 are one-to-one correspondence. The processor 4 is further configured to control the virtual key K1 corresponding to the current touch position to highlight according to the current touch position where the sliding touch is performed on the first touch pad 31, so as to inform the user that the virtual key K1 can be currently selected for input. The processor 4 determines the virtual ley K1 to be the selected virtual key K1 when the touch position corresponding to the virtual key K1 remains for a preset time duration. For example, as shown in FIG. 4, when the first touch action is sliding to a touch position corresponding to the letter “A”, the letter “A” is highlighted. If the user determines that the current highlighted virtual key K1 is the virtual key K1 selected by the user to be input, and then remains at the current touch position for the preset time duration, the letter “A” on the selected virtual key K1 can be input. Therefore, when the sliding touch is performed, the virtual key K1 highlighted every time the touch position corresponding to the virtual key K1 is passed. Therefore, the highlighted virtual key K1 is also sequentially changed along with the touch position.

The highlighted of the virtual key K1 may be increasing brightness, or displaying a color different from other virtual keys K1, or adding a special mark such as a circle, and the like.

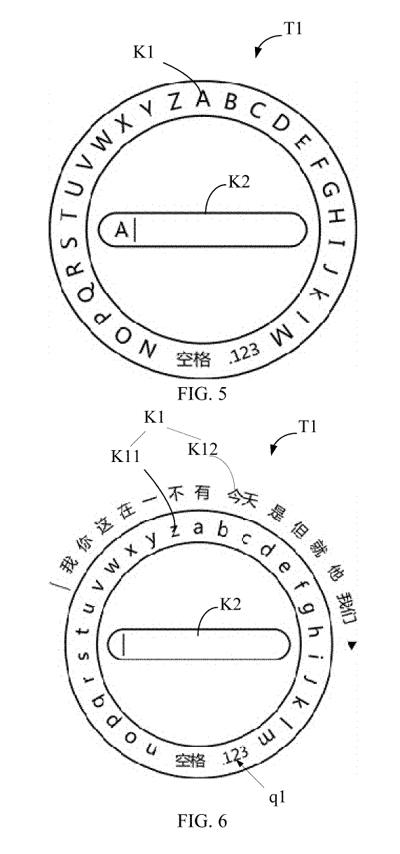

The soft keyboard input interface T1 further includes an input box K2. Referring to FIG. 5, the character of the selected virtual key K1, controlled by the processor 4, is displayed in the input box K2 when the selected virtual key K1 to be input is the character. For example, as shown in FIG. 5, the letter “A”, controlled by the processor 4, is displayed in the input box K2 when the letter “A” is determined to be the selected virtual key K1 to be input.

The input box K2 is surrounded by the plurality of virtual keys K1 arranged circularly, and is located in a ring formed by the plurality of virtual keys K1 arranged circularly. That is, the plurality of virtual keys K1 are arranged around the input box K2 circularly.

As shown in FIG. 3, the touch input apparatus 3 further includes a second touch pad 32. The second touch pad 32 is also configured to detect touch operations. In some embodiments, as shown in FIG. 3, the second touch pad 32 can be a circular touch pad surrounded by the annular first touch pad 31. In other embodiments, the second touch pad 32 can be also an annular touch pad surrounded by the first touch pad 31, and an outer diameter of the second touch pad 32 is substantially equal to an inner diameter of the first touch pad 31. In other embodiments, the second touch pad 32 can be located at a periphery of the first touch pad 31, that is, surrounding the first touch pad 31.

The processor 4 is further configured to delete the character input in the input box K2 in response to a second touch action applied to the second touch pad 32. Where, the second touch action can be a back and forth sliding touch sliding along a predefined direction applied to the second touch pad 32. In some embodiments, the number of deleted characters, controlled by the processor 4, varies along with the distance of back and forth sliding touch applied to the second touch panel 32. That is, the processor 4 deletes the corresponding number of characters according to the distance of back and forth sliding touch applied to the second touch panel 32. For example, the processor 4 deletes one character input in the input box K2 according to a distance, which is less than a first preset distance, of back and forth sliding touch applied to the second touch panel 32; and deletes all characters input in the input box K2 when a distance, which is greater than a second preset distance, of back and forth sliding touch applied to the second touch pad 32 Where, the second preset distance is greater than the first preset distance.

The back and forth sliding touch refers to a sliding touch operation including at least a first sliding direction and a second sliding direction. Where, the first sliding direction and/or the second sliding direction are the same as a preset direction, and the distance of the sliding distance of the back and forth sliding touch projected on the second sliding direction is greater than a predetermined distance, for example, which is greater than 0. In another embodiment, the angle between the first sliding direction and the second sliding direction is less than 90°. The distance of the back and forth sliding touch is equal to a sliding distance in the second sliding direction, or a distance of a sliding distance in the second sliding direction projected onto the first sliding direction, or the difference between the distance in the first sliding direction and the distance of a sliding distance in the second sliding direction projected on the first sliding direction.

As shown in FIG. 3, the touch input apparatus 3 further includes a proximity sensor 33. The proximity sensor 33 may be located in an area of the first touch pad 31 and/or the second touch pad 32. The proximity sensor 33 is configured to detect a close-range non-contact gesture of the user. The processor 4 is further configured to control a language category of the virtual key K1 displayed by the soft keyboard input interface T1 to be switched in response to the preset gesture detected by the proximity sensor 33.

Referring to FIG. 6, for example, the language category of the current virtual key K1 of the soft keyboard input interface T1 is capital letter category as shown in FIG. 4 or FIG. 5. The processor 4 controls the language category of the current virtual key K1 of the soft keyboard input interface T1 to be switched to the Chinese Pinyin category shown in FIG. 6 when the proximity sensor 33 detects the preset gesture. Where, as shown in FIG. 6, the virtual key K1 of the Chinese Pinyin category includes a pinyin lowercase letter K11 arranged in a ring shape, and a common Chinese character K12 surrounding an outer ring of the pinyin lowercase letter.

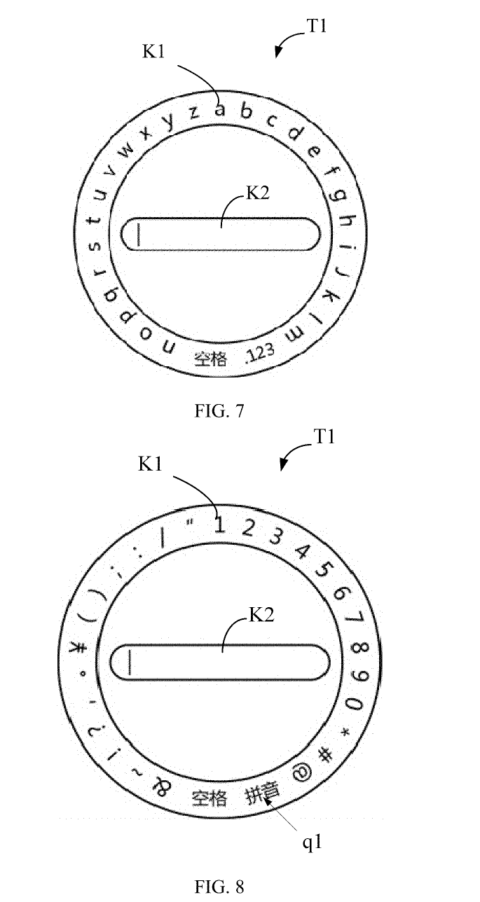

Referring further to FIG. 7, the language category of the virtual keyboard displayed by the soft keyboard input interface T1 further includes the lowercase letter category shown in FIG. 7. The processor 4 controls the language category of the current virtual key K1 of the soft keyboard input interface T1 to be switched to the lowercase letter category shown in FIG. 7 when the proximity sensor 33 detects the preset gesture again.

Referring further to FIG. 8, the language category of the virtual keyboard displayed by the soft keyboard input interface T1 also includes the number and punctuation category shown in FIG. 8. The processor 4 controls the language category of the current virtual key K1 of the soft keyboard input interface T1 to be switched to the numeric and punctuation category as shown in FIG. 8 when the proximity sensor 33 detects the preset gesture again.

Obviously, the language category of the virtual key K1 displayed by the soft keyboard input interface T1 may further include other categories, and the user may switch the language category of the virtual key K1 by executing the preset gesture until switching to a required language category.

In one embodiment, the preset gesture may be a gesture of non-contact unidirectional motion or a non-contact back and forth motion along a direction parallel to the surface of the touch input apparatus 3. In another embodiment, the preset gesture may be a gesture of non-contact back and forth motion in a direction perpendicular to the surface of the touch input apparatus 3, or the like.

As shown in FIG. 5 or FIG. 7, the virtual key K1 of the soft keyboard input interface T1 may further include a language category switching button q1, and the processor 4 also switches the language category of the virtual key K1 in response of clicking on the language category switching button q1. For example, as shown in FIG. 5, when the language category of the current virtual key K1 is the Chinese Pinyin category, the soft keyboard input interface T1 displays a language category switching button q1 having a content of “0.123”, and the processor 4 controls the language category of the virtual key K1 to be switched to the numeric and punctuation category in response of clicking the language category switching button q1. For another example, when the current language category of the virtual key K1 is numeric and punctuation category, the soft keyboard input interface T1 displays a language category switching button q1 having a content of “Pinyin”, and the processor 4 controls the language category of virtual key K1 to be switched to the Chinese Pinyin category in response of clicking the language category switching button q1.

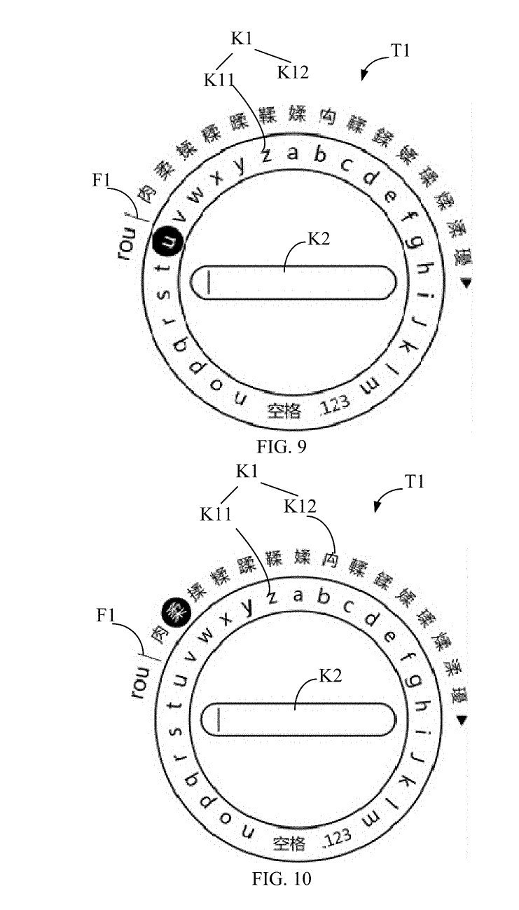

Referring to FIGS. 9-11, an example of an input process when the language category of the current virtual key K1 of the soft keyboard input interface T1 is the Chinese pinyin category is provided. As shown in FIG. 8, the processor 4 sequentially selects pinyin letters of Chinese characters in response to multiple first touch actions input on the first touch pad 31, such as “rou” as shown in FIG. 8. For example, the processor 4 confirms the selected pinyin letter “r” in response to the first touch action input on the first touch pad 31 for the first time, and then confirms the selected pinyin letter “o” in response to the first touch action input on the first touch pad 31 for the second time, and then confirms the selected pinyin letter “u” in response to the first touch action input on the first touch pad 31 for the third time, thereby sequentially selecting the pinyin letter “rou”. The plurality of first touch actions for selecting the plurality of pinyin letters may be continuous touch actions without leaving the first touch pad 31. In another embodiment, the interval between the plurality of first touch actions for inputting each pinyin letter of a Chinese character is less than a preset time duration, for example, the the interval between the first touch actions for input of the pinyin letter “r” and the pinyin letter “o” is less than the preset time duration such as 2 S.

As shown in FIGS. 9-11, when the language category of the current virtual key K1 of the soft keyboard input interface T1 is the Chinese Pinyin category, the processor 4 further controls the soft keyboard input interface T1 to display a separation identifier F1. The separation identifier F1 is used to separate the pinyin letters of the Chinese characters and the Chinese characters corresponding to the pinyin letters. For example, as shown in FIG. 9, after selecting the pinyin letter “rou”, the processor 4 displays the pinyin letter “rou” on the left side of the separation identifier F1, and displays the plurality of Chinese characters corresponding to the pinyin letter “rou” in the right side of the separation identifier F1. Wherein, the separation identifier F1 may be a vertical line.

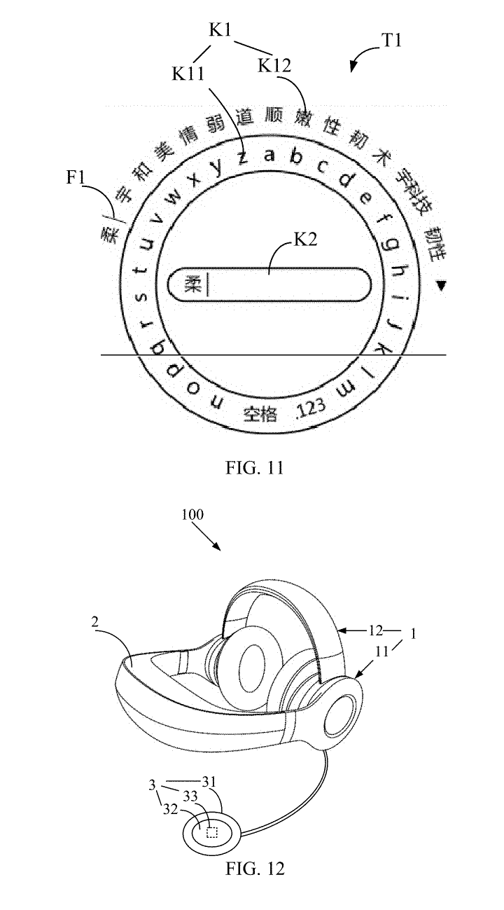

When the first touch action on the first touch pad 31 remains or a third touch action is input on the first touch pad 31, the processor 4 determines that the input of the pinyin letter of the current Chinese character is completed. For example, when the user's finger leaves the first touch pad 31, the current touch action is determined to be remained. In some embodiments, the third touch action is a touch action of a “√” shaped touch action. When the pinyin letters are input, a plurality of Chinese characters corresponding to the input pinyin letters, controlled by the processor 4, are displayed, and the first character of the plurality of Chinese characters is highlighted. At this time, it indicates that the user will perform a further selection operation on the plurality of Chinese characters. The processor 4 continues to determine the Chinese character to be input in response to the first touch action input on the first touch pad 31 once again. For example, as shown in FIG. 10, after inputting the pinyin letters of the current Chinese character, different Chinese characters are highlighted, controlled by the processor 4, according to the change of the sliding position when the first touch action is input on the first touch pad 31. After the touch action remains for a predetermined time duration at a position of a Chinese character such as a “ [symbol] ” character, the “ [symbol] ” is determined to be the Chinese character to be input. As shown in FIG. 11, the “ [symbol] ”, controlled by the processor 4, is displayed in the input box K2, thereby completing the input of the “ [symbol] ” character.

As shown in FIG. 11, the processor 4 is further configured to display the input “ [symbol] ” character on one side of the separation identifier F1 after inputting the “ [symbol] ” character, and display the associated character of the “ [symbol] ” character on the other side of the separation identifier F1. Similarly, when the input of the “ [symbol] ” character is completed, the processor 4 determines that the “ [symbol] ” character is input when the first touch action on the first touch pad 31 remains or the third touch action is input on the first touch pad 31, and continues to determine the next character to be input from the associated character in response to the first touch action input on the first touch pad 31 once again.

The processor 4 further controls the display apparatus 2 to return to an initial interface for displaying the virtual keys K11 having 26 all letters of the pinyin letter category and having the Chinese Pinyin category with the commonly used Chinese characters K12 as shown in FIG. 6 in response to a fourth touch action input on the first touch pad 31.

The fourth touch action may be a flick touch action along a certain direction. The flicking touch action can sweep the first touch pad 31 in one direction and make a short touch contact with the first touch pad 31.

The input box K2 may be an input box of an application software or a system software, and the content input request is generated after the user clicks on the input box K2. The application software may be a browser search toolbar, a short message input box, an audio and video player search bar, and the like.

In some embodiments, when the display apparatus 2 does not display the soft keyboard input interface T1, that is, when no input of characters or the like is performed, the processor 4 also performs a specific operation on the currently displayed page content or the currently open application in response to the input on the first touch pad 31, the second touch pad 32 and/or the proximity sensor 33 of the touch input apparatus 3.

For example, the processor 4 can control pointer movement, page drag, and the like in response to a sliding touch on the first touch pad 31 and/or the second touch pad 32 of the touch input apparatus 3. The processor 4 can control to open a specific object or enter a next level folder or the like in response to a click operation on the first touch pad 31, the second touch pad 32 of the touch input apparatus 3. For example, when the pointer moves to an application or an application is selected by click, the application can be opened by performing a click operation on the first touch pad 31, the second touch pad 32 of the touch input apparatus 3. For another example, when the audio and video player is currently turned on, the processor 4 can control the volume, brightness, and the like of the audio and video player in response to a sliding touch on the first touch pad 31 and/or the second touch pad 32 of the touch input apparatus 3.

In some embodiments, the processor 4 controls the pointer to move to the input box K2 in response to a sliding touch on the first touch pad 31 and/or the second touch pad 32 of the touch input apparatus 3, the content input request may be generated in response to a click touch (click or double click) input on the first touch pad 31 and/or the second touch pad 32.

In some embodiments, for example, the processor 4 may also perform a specific operation on the currently displayed page content or the currently open application in response to a gesture action detected by the proximity sensor 33 of the touch input apparatus 3. For example, the processor 4 can control the parameters such as volume, brightness, and the like of the audio and video player in response to a hovering gesture detected by the proximity sensor 33.

As shown in FIG. 1, in some embodiments, the touch input apparatus 3 is located on the headphone apparatus 1. The headphone apparatus 1 includes two receivers 11 and one headphone bracket 12. For example, the first touch pad 31 and the second touch pad 32 of the touch input apparatus 1 are located on an outer surface of the receiver 11 of the headphone apparatus 1. The first touch pad 31 is located on an outer ring area of the receiver 11, and the second touch pad 32 is located on a center area of the receiver 11.

Referring to FIG. 12, in other embodiments, the touch input apparatus 3 can be a separate input device coupled to the headset apparatus 1 or the display apparatus 2 by wire or wirelessly. For example, the touch input apparatus 3 can be a mouse-like device for the user to input.

In the present disclosure, the first touch pad 31, the second touch pad 32 of the touch input apparatus 3 are configured for detecting a touch action of a user to generate a touch sensing signal. The processor 4 is configured for receiving the touch sensing signal to determine a touch action input on the first touch pad 31 and the second touch pad 32. The proximity sensor 33 of the touch input apparatus 3 is configured to detect a short-distance gesture of the user to generate a sensing signal, and the processor 4 receives the sensing signal generated by the proximity sensor 33 to determine the short-distance gesture of the user detected by the proximity sensor 33.

The processor 4 can be a processing chip such as a central processor, a micro controller, a micro processor, a single chip microcomputer, or a digital signal processor.

The processor 4 can be located in the headphone apparatus 1 or located in the display apparatus 2.

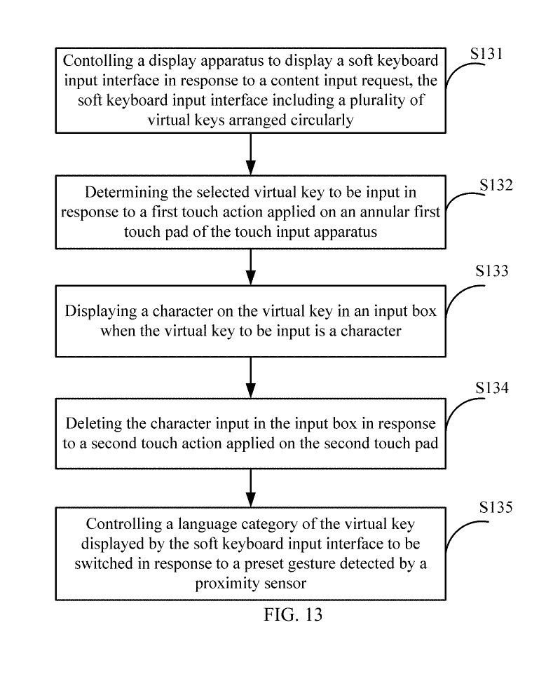

Referring to FIG. 13, a flowchart of content input method according to one embodiment of the present disclosure is provided. The method is applied to the above head mounted display device 100. The method comprises steps of:

The display apparatus 2 is controlled to display a soft keyboard input interface T1 in response to a content input request, and the soft keyboard input interface T1 includes a plurality of virtual keys K1 arranged circularly (S131). In one embodiment, the content input request is generated after the user clicks on the input box K2.

The selected virtual key K1 to be input is determined in response to a first touch action applied to the first touch pad 31 of the touch input apparatus 3 (S132). Specifically, the step S133 includes: a virtual key K1 corresponding to a current touch position is determined in response to a sliding touch of the first touch pad 31, and the virtual key K1 is highlighted; the highlighted virtual key K1 is selected as the virtual key K1 to be input when the touch position corresponding to the highlighted virtual key K1 remains for the preset time duration. Where, the highlighted can be increasing brightness, displaying a color different from other virtual key K1, adding special marks such as circles around the virtual key K1, and the like.

When the virtual key K1 to be input is a character, the character, that is, the character on the virtual key K1 is displayed in the input box K2 (S133).

In some embodiments, the content input method further comprises steps:

The character input in the input box K2 is deleted in response to a second touch action applied to the second touch pad 32 (S134). Where, the second touch action can be a back and forth sliding touch sliding along a predefined direction applied to the second touch pad 32. In some embodiments, the step S134 further includes: the corresponding number of characters are deleted according to the distance of back and forth sliding touch applied to the second touch panel 32.

In some embodiments, the content input method further comprises steps: a language category of the virtual key K1 displayed by the soft keyboard input interface T1 is controlled to be switched in response to the preset gesture detected by the proximity sensor 33 (S135).

In some embodiments, the content input method further comprises steps:

When the display apparatus 2 does not display the soft keyboard input interface T1, the processor 4 also performs a specific operation on the currently displayed page content or the currently open application in response to the input on the first touch pad 31, the second touch pad 32 and/or the proximity sensor 33 of the touch input apparatus 3.

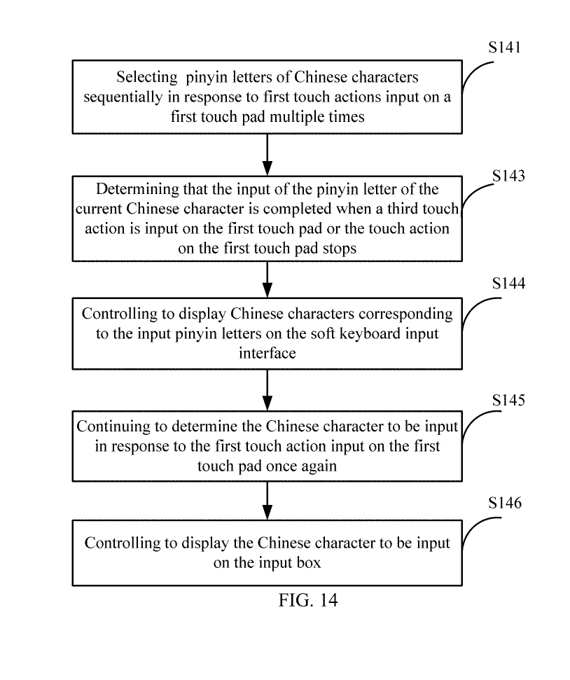

Referring to FIG. 14, a flowchart of a content input method when the language category of the virtual key K1 displayed by the soft keyboard input interface T1 is a Chinese pinyin category is provided. Where, the method comprises the steps of:

The processor 4 sequentially selects pinyin letters of Chinese characters in response to multiple first touch actions input on the first touch pad 31 (S141). For example, the processor 4 confirms the selected pinyin letter “r” in response to the first touch action input on the first touch pad 31 for the first time, and then confirms the selected pinyin letter “o” in response to the first touch action input on the first touch pad 31 for the second time, and then confirms the selected pinyin letter “u” in response to the first touch action input on the first touch pad 31 for the third time, thereby sequentially selecting the pinyin letter “rou”. Where, the plurality of first touch actions for selecting the plurality of pinyin letters may be continuous touch actions without leaving the first touch pad 31.

The processor 4 determines that the input of the pinyin letter of the current Chinese character is completed when a third touch action is input on the first touch pad 31 or the touch action on the first touch pad 31 remains (S143). For example, when the user's finger leaves the first touch pad 31, the current touch action is determined to be remained. In some embodiments, the third touch action is a touch action of a “√” shaped touch action.

The Chinese characters corresponding to the input pinyin letters, controlled by the processor 4, are displayed on the soft keyboard input interface T1 (S144).

The processor 4 continues to determine the Chinese character to be input in response to the first touch action input on the first touch pad 31 once again (S145). For example, as shown in FIG. 10, after inputting the pinyin letters of the current Chinese character, different Chinese characters are highlighted according to the change of the sliding position when the first touch action is input on the first touch pad 31. After the touch action remains for a predetermined time at a position of a Chinese character such as a “ [symbol] ” word, the “ [symbol] ” is determined to be the Chinese character to be input.

The Chinese character to be input, controlled by the processor 4, is displayed on the input box K2 (S146).

In some embodiment, the method further comprises steps: the processor 4 further controls the soft keyboard input interface T1 to display a separation identifier F1, and display an input Chinese character on one side of the separation identifier F1, and display associated characters of the “ [symbol] ” character on other side of the separation identifier F1; the processor 4 further continues to determine the next character to be input from the associated characters in response to the first touch action input on the first touch pad 31 once again.

In some embodiment, the method further comprises steps: the processor 4 further controls the soft keyboard input interface T1 to return to an initial interface having a Chinese Pinyin category in response to a fourth touch action input on the first touch pad 31. Where, the fourth touch action may be a flick touch action along a certain direction.

Therefore, the electronic device 100 and the soft keyboard display method of the present disclosure can automatically determine the category of the user and display a soft keyboard conforming to the user category.

The above is a preferred embodiment of the present disclosure, and it should be noted that those skilled in the art may make some improvements and modifications without departing from the principle of the present disclosure, and these improvements and modifications are also the protection scope of the present disclosure.

What is claimed is:

1. A head mounted display device, comprising a headphone apparatus, a display apparatus, a touch input apparatus, and a processor; wherein, the touch input apparatus comprises a first touch pad; the first touch pad is configured to detect touch operations; the processor is configured to control the display apparatus to display a soft keyboard input interface in response to a content input request; the soft keyboard input interface comprises an input box and a plurality of virtual keys arranged circularly; the processor is configured to determine a virtual key to be input in response to a first touch action applied to the first touch pad, and display a character in the input box when the virtual key to be input is determined to be the character.

2. The head mounted display device according to claim 1, wherein the first touch action refers to a sliding touch along a circular track on the first touch pad and remaining for a preset time duration at a corresponding touch position of the virtual key to be input.

3. The head mounted display device according to claim 2, wherein touch positions on the first touch pad is in a one-to-one correspondence with positions of the virtual keys on the soft keyboard input interface, and the processor is further configured to determine a current touch position when a sliding touch is performed on the first touch pad, and control the virtual key corresponding to the current touch position to be highlighted, and the processor is further configured to determine a highlighted virtual key as the virtual key to be input in response to remaining at the touch position corresponding to the highlighted virtual key for the preset time duration.

4. The head mounted display device according to claim 3, wherein highlighted of the virtual key comprises at least one of increasing brightness, displaying a color different from the other virtual keys, and adding special marks.

5. The head mounted display device according to claim 1, wherein the touch input apparatus further comprises a second touch pad, and the processor is further configured to delete characters entered in the input box in response to a second touch action applied to the second touch pad.

6. The head mounted display device according to claim 5, wherein the second touch action refers to a back and forth sliding touch along a preset direction on the second touch pad; the processor deletes corresponding number of characters according to a distance of the back and forth sliding touch on the second touch pad.

7. The head mounted display device according to claim 5, wherein the touch input apparatus further comprises a proximity sensor located in an area of the first touch pad and/or the second touch pad; the proximity sensor is configured to detect a close-range non-contact gesture of a user, and the processor is further configured to switch a language category of the virtual keys displayed by the soft keyboard input interface in response to a preset gesture detected by the proximity sensor.

8. The head mounted display device according to claim 7, wherein the preset gesture is a gesture of non-contact unidirectional motion or a non-contact back and forth motion along a direction parallel to a surface of the touch input apparatus, or a gesture of non-contact back and forth motion in a direction perpendicular to a surface of the touch input apparatus.

9. The head mounted display device according to claim 7, wherein the language category of the virtual key displayed by the soft keyboard input interface comprises a capital letter category, a Chinese pinyin category, a lowercase letter category, and a numeric and punctuation category.

10. The head mounted display device according to claim 9, wherein when the language category of the virtual keys displayed by the soft keyboard input interface is the Chinese pinyin category, the processor sequentially selects pinyin letters of Chinese characters in response to multiple first touch actions input on the first touch pad; the processor determines that inputs of the pinyin letters of the current Chinese character is completed when a third touch action is input on the first touch pad or the first touch action on the first touch pad remains; the processor displays a plurality of Chinese characters corresponding to the input pinyin letters on the soft keyboard input interface; the processor continues to determine a Chinese character to be input in response to the first touch action input on the first touch pad once again.

11. The head mounted display device according to claim 9, wherein the processor further controls the soft keyboard input interface to display a separation identifier, and displays an input Chinese character on one side of the separation identifier, and displays associated characters of the input Chinese character on other side of the separation identifier; the processor further continues to determine a next character to be input from associated characters in response to the first touch action input on the first touch pad once again.

12. The head mounted display device according to claim 1, wherein the touch input apparatus is located on the headphone apparatus, or the touch input apparatus is independent from the display apparatus and the headphone and is in communication with the display apparatus by wire or wirelessly.

13. The head mounted display device according to claim 1, wherein the plurality of circularly arranged virtual keys are arranged around the input box.

14. A content input method, applied to a head mounted display device comprising a headphone apparatus, a display apparatus, and a touch input apparatus, wherein the method comprises steps of:
controlling the display apparatus to display a soft keyboard input interface in response to a content input request, the soft keyboard input interface comprising an input box and a plurality of virtual keys arranged circularly;
determining a virtual key to be input in response to a first touch action applied to a first touch pad of the touch input apparatus; and
displaying a character in the input box when the virtual key to be input is determined to be the character.

15. The content input method according to claim 14, wherein the step of “determining a virtual key to be input in response to a first touch action applied to a first touch pad of the touch input apparatus” comprises:
determining a certain virtual key as the virtual key to be input in response to a sliding touch along a circular track on the first touch pad and remaining at a corresponding touch position of the virtual key for a preset time duration.

16. The content input method according to claim 15, wherein touch positions on the first touch pad has a one-to-one correspondence with positions of the virtual keys on the soft keyboard input interface, and the step “determining a virtual key to be input in response to an annular first touch action applied to a first touch pad of the touch input apparatus” comprises:
determining a current touch position when a sliding touch is performed on the first touch pad, and controlling the virtual key corresponding to the current touch position to be highlighted, wherein the highlighted of the virtual key comprises increasing brightness, displaying a color different from other virtual keys, and adding special marks;
determining a highlighted virtual key as the virtual key to be input when the touch position corresponding to the highlighted virtual key remains for the preset time duration.

17. The content input method according to claim 14, wherein the touch input apparatus further comprises a second touch pad, the method further comprising:
deleting the character input in the input box in response to a second touch action input on the second touch pad.

18. The content input method according to claim 17, wherein the second touch action refers to a back and forth sliding touch along a preset direction on the second touch pad, the step “deleting the character input in the input box in response to the second touch action input on the second touch pad” comprises:
deleting corresponding number of characters according to a distance of back and forth sliding touch applied to the second touch pad.

19. The content input method according to claim 14, wherein the touch input apparatus further comprises a proximity sensor located in an area of the first touch pad and/or the second touch pad; the proximity sensor is configured for detecting a short-distance non-contact gesture of the user, the method further comprises:
controlling the language category of the virtual key displayed by the soft keyboard input interface to be switched in response to a preset gesture detected by the proximity sensor.

20. The content input method according to claim 19, wherein the preset gesture is a gesture of non-contact unidirectional motion or a non-contact back and forth motion along a direction parallel to a surface of the touch input apparatus, or a gesture of non-contact back and forth motion in a direction perpendicular to the surface of the touch input apparatus.
